(19) United States
(12) Patent Application Publication
(10) Pub. No.: US 2014/0150327 A1
(43) Pub. Date: Jun. 5, 2014

(54) FLOATATION DEVICE

(71) Applicants: Anthony Jordan Craig, Lake Stevens, WA (US); Justin Knowles, Sammamish, WA (US)

(72) Inventors: Anthony Jordan Craig, Lake Stevens, WA (US); Justin Knowles, Sammamish, WA (US)

(21) Appl. No.: 14/175,133

(22) Filed: Feb. 7, 2014

Related U.S. Application Data
(63) Continuation-in-part of application No. 13/419,338, filed on Mar. 13, 2012.

(51) Int. Cl. A01K 75/04

(52) U.S. Cl. CPC A01K 75/04
USPC 43/14

(57) ABSTRACT

A floatation device. The floatation device may comprise: at least two float portions and one or more fasteners. The two float portions may be opposing halves of a floatation float configured to form a float when combined. The one or more fasteners may be aligned and positioned on the outer side of the two float portions, such that, when the fasteners engage with each other, the two float portions form as a float. The fasteners may be strap fasteners. Accordingly, the float portions may fasten together on a fishing line after mating the fasteners. To increase the strength of the fastening the devices, an adhesive fastener may be included on the contact surfaces of the float portions. Each float portion may also comprise a recess and a projection for mating or engaging. The floatation device is particularly useful as a floating support for seines and commercial fishing nets.

### CROSS REFERENCE TO RELATED APPLICATIONS

This application is a continuation-in-part of U.S. Non-Provisional patent application Ser. No. 13/419,338, filed on Mar. 13, 2012, titled “Seine Floatation Device”, by inventor Anthony Jordan Craig, the contents of which are expressly incorporated herein by this reference, and to which priority is claimed.

### FIELD OF THE INVENTION

The present disclosure generally relates to floatation devices for fishing nets, and more particularly, floatation devices for commercial fishing nets that can easily attach onto the net through the use of fasteners such as insert fasteners and strap fasteners, and/or protrusions.

### BACKGROUND OF THE INVENTION

Commercial fishing nets have been used for centuries and are well known in the art. Fishermen simply cast a net into the water, drag the net over areas where fish may be abundant, and pull the net to catch one or more fishes. Examples of such nets generally include cast nets, coracle fishing nets, dragnets, drift nets, gillnets, hand nets, lave nets, lift nets, stake nets, tangle nets, trammels, and trawls, and the like.

Each fishing net or fishnet is generally constructed from fibers woven in a grid-like structure and are generally comprised of floats. For example, some fishing nets (e.g., gillnets, seines) may be configured to hang vertically in the water by means of floats and sinkers. The sinkers are attached along one end of the net and function as weights. Attached on the opposite end of the net are floats, which function as floatation devices. As the sinkers pull the net downward into the water, the net stretches due to the upward pull of the floatation devices and function similar to a fence for capturing fish. Other fishing nets such as longlines and driftnets also typically utilize floats to capture fish also by hanging in the water.

Despite its benefits, preparing floats for fishing nets is often cumbersome and time-consuming A fisherman typically spends hours in preparing a single fishnet, which usually contains thousands of floats. Because each individual float may be removed and/or replaced approximately four or five at a time, this indeed becomes especially tedious with nets that are approximately three football fields long. Additionally, continuous use of fishing nets eventually results with lost or damaged floats, causing fishing nets to sink into the water. This likely causes fishermen to lose fish, which, in turn, results with losses in time and money. Accordingly, it would be beneficial to have a fishnet with floats that can be easily repaired or replaced.

Therefore, what is needed is a floatation device that can be easily assembled or prepared by simply adding or replacing the fishing net's floats. The floats may be fastened onto the nets through various fasteners such as snap fasteners and strap fasteners.

### SUMMARY OF THE INVENTION

To minimize the limitations in the prior art, and to minimize other limitations that will become apparent upon reading and understanding the present specification, the present disclosure discloses a new and useful floatation device for fishing nets.

One embodiment may be a floatation device for fishing nets, comprising: two or more float portions; and one or more pairs of fasteners. The two or more float portions are configured to form a float when combined, and the one or more pairs of fasteners are aligned and embedded inside the two or more float portions, such that, when the one or more pairs of fasteners engage, the two or more float portions combine to form the float. The one or more pairs of fasteners may comprise one or more male fasteners and one or more female fasteners. The two or more float portions may comprise one or more contact surfaces, and the one or more contact surfaces may comprise an adhesive. The adhesive may increase a fastening strength of the one or more pairs of fasteners when the two or more float portions combine. The two or more float portions, when combined, should form one or more through holes, and the one or more through holes are typically configured to interconnect with a fishing net. The two or more float portions may be two float portions. The one or more male fasteners may be two male fasteners; and the one or more female fasteners may be two female fasteners. The one or more male fasteners may be three male fasteners; and the one or more female fasteners may be three female fasteners. The one or more male fasteners may be four male fasteners; and the one or more female fasteners may be four female fasteners.

Another embodiment may be a floatation device for fishing nets, comprising two or more float portions. The two or more float portions are configured to form a float when combined, and the two or more float portions may comprise one or more protrusions and one or more holes. The one or more protrusions and the one or more holes are aligned on the two or more float portions, such that, when the one or more protrusions engage with the one or more holes, the two or more float portions combine to form the float. The two or more float portions may comprise one or more contact surfaces. The one or more contact surfaces may comprise an adhesive. The adhesive may increase a fastening strength of the one or more protrusions and the one or more holes when the two or more float portions combine. The two or more float portions, when combined, may form one or more through holes; wherein the one or more through holes are configured to interconnect with a fishing net. The two or more float portions may be two float portions. The one or more protrusions may be two protrusions; and the one or more holes may be two holes. The one or more protrusions may be three protrusions; and the one or more holes may be three holes. The one or more protrusions may be four protrusions; and the one or more holes may be four holes.

Another embodiment may be a floatation device for fishing nets, comprising: two float portions and three pairs of fasteners. The two float portions are configured to form a float when combined. The three pairs of fasteners are aligned and embedded inside the two float portions, such that, when the three pairs of fasteners engage, the two float portions combine to form the float. The two or more float portions may comprise one or more contact surfaces. The one or more contact surfaces may comprise an adhesive. The adhesive increases a fastening strength of the three pairs of fasteners when the two or more float portions combine. The two or more float portions, when combined, form one or more through holes; and the one or more through holes are configured to interconnect with a fishing net.

Another embodiment may be a floatation device for fishing nets, comprising: two or more float portions; and one or more fasteners; wherein the two of more float portions are configured to form a float when combined; wherein the one or more fasteners are aligned and positioned outside the two or more float portions, such that, when at least one of the one or more fasteners engage with each other, the two or more float portions combine to form the float. A first end of the one or more fasteners may comprise at least one male fastener; and wherein a second end of the one or more fasteners may comprise at least one female fastener. The one or more fasteners may be one or more strap fasteners. The two or more float portions may comprise one or more contact surfaces; wherein the one or more contact surfaces may comprise an adhesive; and wherein the adhesive may increase a fastening strength of the one or more fasteners when the two or more float portions combine. The two or more float portions may be two float portions. The two or more float portions may be three float portions. The one or more fasteners may be two fasteners. The one or more fasteners may be three fasteners. The two or more float portions may be configured to float. The two or more float portions, when combined, may form one or more through holes; wherein the one or more through holes may be configured to engage with a fishing net. A first lateral side of a portion of the one of more through holes may comprise at least one recess; and wherein a second lateral side of the portion of the one of more through holes may comprise at least one protrusion, such that, when the recess and the protrusion of the two or more float portions engage, the two or more float portions may combine to form the float.

Another embodiment may be a floatation device for fishing nets, comprising: two or more float portions; and one or more strap fasteners; wherein the two of more float portions are configured to form a float when combined; wherein the one or more strap fasteners are aligned and positioned outside the two or more float portions, such that, when the one or more strap fasteners engage with each other, the two or more float portions combine to form the float. The two or more float portions may comprise one or more contact surfaces; wherein the one or more contact surfaces may comprise an adhesive; and wherein the adhesive may increase a fastening strength of the one or more fasteners when the two or more float portions combine. The two or more float portions may be two float portions. The two or more float portions may be configured to float. The one or more strap fasteners may be two strap fasteners. The one or more strap fasteners may be three strap fasteners. The two or more float portions, when combined, may form one or more through holes; wherein the one or more through holes may be configured to engage with a fishing net. A first lateral side of a portion of the one of more through holes may comprise at least one recess; and wherein a second lateral side of the portion of the one of more through holes may comprise at least one protrusion, such that, when the at least one recess and the at least one protrusion of the two or more float portions engage, the two or more float portions may combine to form the float.

Another embodiment may be a floatation device for fishing nets, comprising: a first float portion; a second float portion; one or more first strap fasteners; and one or more second strap fasteners; wherein the first float portion and the second float portion are configured to form a float when combined; wherein the one or more first strap fasteners are aligned and positioned outside the first float portion and wherein the one or more second strap fasteners are aligned and positioned outside the second float portion, such that, when the one or more first strap fasteners engage with the second strap fasteners, the first float portion and the second float portion combine to form the float; wherein the two or more float portions comprise one or more contact surfaces; wherein the one or more contact surfaces comprise an adhesive; wherein the adhesive increases a fastening strength of the one or more fasteners when the two or more float portions combine; wherein the two or more float portions are configured to float; wherein the two or more float portions, when combined, form one or more through holes; wherein the one or more through holes are configured to engage with a fishing net; wherein a first lateral side of a portion of the one of more through holes comprises at least one recess; and wherein a second lateral side of the portion of the one of more through holes comprises at least one protrusion, such that, when the at least one recess and the at least one protrusion of the two or more float portions engage, the two or more float portions combine to form the float.

Another embodiment may be a floatation device for fishing nets, comprising: one or more float portions; and one or more fasteners; wherein said one or more float portions are configured to engage onto a portion of a fishing net; wherein said one or more fasteners are configured to fasten and secure said one or more float portions around said portion of said fishing net, such that, when said one or more fasteners fasten said one or more float portions around said portion of said fishing net, said one or more float portions function as a float. A first end of said one or more fasteners may comprise at least one male fastener; and wherein a second end of said one or more fasteners may comprise at least one female fastener. The one or more fasteners may be one or more strap fasteners. The one or more float portions may be at least two float portions; wherein said at least two float portions may comprise one or more contact surfaces; wherein said one or more contact surfaces may comprise an adhesive; and wherein said adhesive may increase a fastening strength of said one or more fasteners when said at least two float portions combine into said float. The one or more float portions may be one float portion. The one or more float portions may be two float portions. The portion of said fishing net may be a rope portion. The one or more fasteners may be three fasteners. The one or more float portions may be configured to float. The one or more float portions, when combined, may form one or more through holes; wherein said one or more through holes may be configured to engage with said portion of said fishing net. The one or more float portions may be two float portions, a first portion and a second portion; wherein each of said two float portions may be further comprised of at least one recess and at least one protrusion; wherein said at least one recess of said first portion may be configured to engage with said protrusion of said second portion; and wherein said at least one recess of said second portion may be configured to engage with said protrusion of said first portion.

Another embodiment may be a floatation device for fishing nets, comprising: two or more float portions; and one or more fasteners; wherein said two or more float portions are configured to engage onto a rope portion of a fishing net; wherein said two of more float portions are configured to form a float when combined; wherein said one or more fasteners are aligned and positioned on an outside surface of said two or more float portions; and wherein said one or more fasteners are configured to fasten and secure said two or more float portions around said rope portion of said fishing net, such that, when said one or more fasteners fasten said two or more float portions around said rope portion of said fishing net, said two or more float portions combine to form a float. The two or more float portions may comprise one or more contact surfaces; wherein said one or more contact surfaces may comprise an adhesive; and wherein said adhesive may increase a fastening strength of said one or more fasteners when said two or more float portions combine. The two or more float portions may be two float portions, a first float portion and a second float portion. The two or more float portions may be configured to float. The one or more fasteners may be two fasteners. The one or more fasteners may be three fasteners. The two or more float portions, when combined, may form one or more through holes; wherein said one or more through holes may be configured to engage with said rope portion of said fishing net. Each of said two float portions may be further comprised of at least one recess and at least one protrusion; wherein said at least one recess of said first portion may be configured to engage with said protrusion of said second portion; and wherein said at least one recess of said second portion may be configured to engage with said protrusion of said first portion.

Another embodiment may be a floatation device for fishing nets, comprising: two float portions; and three fasteners; wherein said two float portions are a first float portion and a second float portion; wherein said two or more float portions are configured to float; wherein said two float portions are configured to engage onto a rope portion of a fishing net; wherein said two float portions are configured to form a float when combined; wherein said two float portions, when combined, form one or more through holes; wherein said one or more through holes are configured to engage with said rope portion of said fishing net; wherein said three fasteners are aligned and positioned on an outside surface of said two float portions; and wherein said three fasteners are configured to fasten and secure said two float portions around said rope portion of said fishing net, such that, when said three fasteners fasten said two float portions around said rope portion of said fishing net, said two float portions combine to form said float.

It is an object to provide a floatation device for fishing nets, in which a user may easily prepare a whole net.

It is an object to provide a floatation device to allow fishermen to easily replace the floatation devices to save time and money in preparing a fishing net.

It is an object to provide a floatation device that is inexpensive and easy to manufacture.

It is an object to provide a floatation device that is durable.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective-exploded view of one embodiment of the floatation device with fasteners.

FIG. 2 is an illustration of a side view of one embodiment of the floatation device with fasteners embedded in the float portions and shows the floatation device before combining the float portions.

FIG. 3 is an illustration of a cross-sectional side view of one embodiment of the floatation device with fasteners embedded in the float portions and shows the floatation device before combining the float portions.

FIG. 4 is an illustration of a side view of one embodiment of the floatation device and shows the floatation device after combining the float portions.

FIG. 5 is an illustration of a cross-sectional side view of one embodiment of the floatation device with fasteners and shows the floatation device after combining the float portions.

FIG. 6 is an illustration of a perspective view of one embodiment of the floatation device after combining the float portions.

FIG. 7 is an illustration of a perspective view of one embodiment of the floatation device with protrusions and shows the floatation device before combining the float portions.

FIG. 8 is an illustration of a cross-sectional side view of one embodiment of the floatation device with protrusions and shows the floatation device before combining the float portions.

FIG. 9 is an illustration of a cross-sectional side view of one embodiment of the floatation device with protrusions and shows the floatation device after combining the float portions.

FIG. 10 is an illustration of a perspective-exploded view of another embodiment of the floatation device with fasteners.

FIG. 11 is an illustration of a right-side view of one embodiment of a float portion assembly and shows the float portion assembly before combining the float portions.

FIG. 12 is an illustration of a left-side view of one embodiment of the float portion assembly and shows the float portion assembly before combining the float portions.

FIG. 13 is an illustration of a bottom view of one embodiment of the float portion assembly and shows the float portion assembly before combining the float portions.

FIG. 14 is an illustration of a top view of one embodiment of the float portion assembly and shows the float portion assembly before combining the float portions.

FIG. 15 is an illustration of a perspective view of one embodiment of the floatation device and shows the floatation device after combining the float portions.

FIG. 16 is an illustration of a perspective-exploded view of another embodiment of the floatation device.

FIG. 17 is an illustration of a perspective view of one embodiment of the floatation device and shows the floatation device after combining the float portion assemblies.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the term “float” may refer to any floatation device used on a fishing line or net to buoy up the line or net. The terms “fishing net” or “net” may refer to any type of netting device used for fishing, including without limitation, cast nets, coracle fishing nets, Chinese nets, dragnets, drift nets, drive-in nets, fyke nets, gillnets, ghost nets, hand nets, lave nets, lift nets, plankton nets, seines, stake nets, surrounding nets, tangle nets, trammels, and trawls.

As used herein, the term “fastener” generally refers to any device used to help fasten and secure one piece to another piece, including without limitation, insert fasteners, male and female fasteners, straps fasteners (e.g., zip tie fastener, Velcro® strap fasteners, clip strap fasteners), hook and loop fasteners, screws, bolts, wires, nylons, snap hooks, loops, solder, flux, nuts, washers, rivets, turnbuckles, and the like.

As used herein, the term “adhesive” refers to any type of material that adheres or bonds the float portions together, including without limitation, adhesive attached-nylon plastic, animal glue (e.g., bone glue, fish glue, hide glue, hoof glue, rabbit skin glue), albumin glue, casein glue, meat glue, plant-based glue, Canada balsam (natural resin), coccoina, gum Arabic (e.g., postage stamp gum), latex, library past, methyl cellulose, mucilage, resorcinol resin, starch, urea-formaldehyde resin, poslystyrene cement/Butanone, dicloromethane, monomers (acrylonitrile, cyanoacrylate, acrylic, resorcinol glue), polymer glues (epoxy, epoxy putt, ethylene-vinyl acetate, phenol formaldehyde resin, polyamide, polyester resins, polyethylene, polypropylene, polysulfides, polyurethane, polyvinyl acetate, polyvinyl alcohol, polyvinyl chloride, polyvinylpyrrolidone, rubber cement, silicones, and styrene acrylic copolymers.

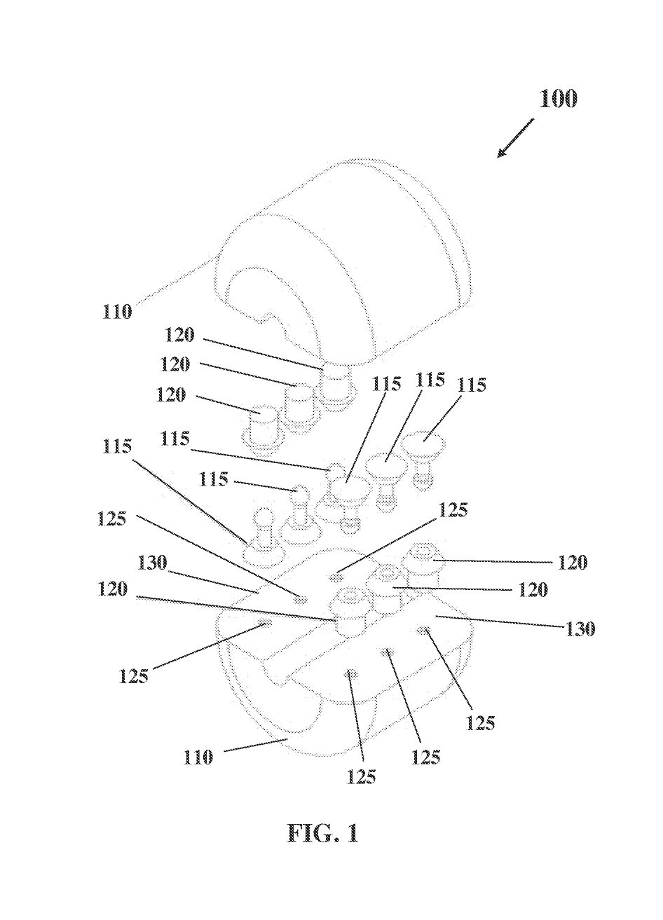

FIG. 1 is an illustration of a perspective-exploded view of one embodiment of the floatation device with fasteners. As shown in FIG. 1, one embodiment of the floatation device 100 may comprise: float portions 110, male fasteners 115, and female fasteners 120. The float portions 110 may be any structural pieces of the floatation device, which may be used for fishing nets such as seines. The float portions 110 may also be configured to form a single, cylindrical float when combined. While FIG. 1 shows an exploded view of a cylindrical-shaped float, the floatation device may be configured in any shape or form such as square, rectangle, oval, and sphere. Additionally, while FIG. 1 only shows two float portions 110 as half pieces of the float, multiple pieces of float portions may be used such as three, four, or five pieces.

FIG. 1 shows the float portions 110 as two half pieces of a single float, which may comprise a plurality of holes 125. The holes are generally configured to accept or receive the male fasteners 115 and/or female fasteners 120. When the fasteners are embedded in the float portions 110, the male fasteners 115 and female fasteners 120 are generally aligned, such that a user may combine the float portions 110 to form the float. Although FIG. 1 only shows only six holes for each float portion 110, the float portion 110 may comprise any number of holes. The float portion 110 may also comprise a contact surface 130, which is typically a flat-surface area in which the float portions 110 contact each other. Although FIG. 1 shows the contact surface 130 as a flat surface area, the contact surface 130 may be unbalanced or irregular without deviating from the scope of the invention. The contact surface 130 may comprise an adhesive to increase the strengthening bond or fastening strength of the fasteners when the float portions 110 combine. The adhesive is typically a glue, epoxy, or cement compound but may be constructed of any manmade or non-manmade composite that increases the fastening strength of the float portions 110.

FIG. 1 shows the male fasteners 115 and female fasteners 120, which may be fastener inserts for the float portions 110. The male fasteners 115 and female fasteners 120 may be embedded in the float portions 110 and are typically configured to secure the float portions 110 together when both the male fasteners 115 and female fasteners 120 engage or mate. As discussed above, the male fasteners 115 and female fasteners 120 may be aligned and embedded inside the holes 125 of the float portions 110, such that when the male fasteners 115 and female fasteners 120 mate or engage, the float portions 110 may combine to form a float. Although FIG. 1 only shows three pairs of male fasteners and female fasteners, any amount of fasteners to be used, so long as the float portions 110 are capable of being combined as a single float.

The float portions 110, male fasteners 115, and female fasteners 120 may be constructed of light-weight materials, including without limitation, high-strength plastic or polymers, but may be constructed of any natural or manmade material such as ethylene vinyl acetate (EVA), polyethylene, polyethylene vinyl acetate (PEVA), polyvinyl chloride (PVC), polyvinyl, polystyrene, fibers, textiles, polyamides, and polycarbonates. The float portions may also be constructed of any other materials such as foam, plastic, metal, cork, and wood. Also, the float may be buoyant, such that when the float is in contact with a liquid surface, the float buoys or floats on the liquid surface.

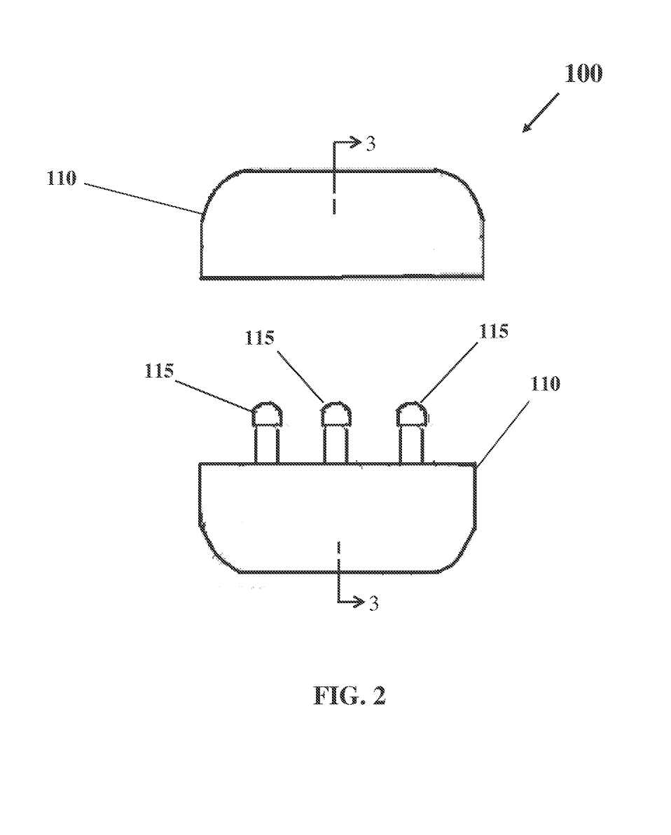

FIG. 2 is an illustration of a side view of one embodiment of the floatation device with fasteners embedded in the float portions and shows the floatation device before combining the float portions. As shown in FIG. 2, one embodiment of the floatation device 100 may comprise float portions 110 and male fasteners 115, and typically comprise female fasteners 120, as shown in FIGS. 1, 3, and 5.

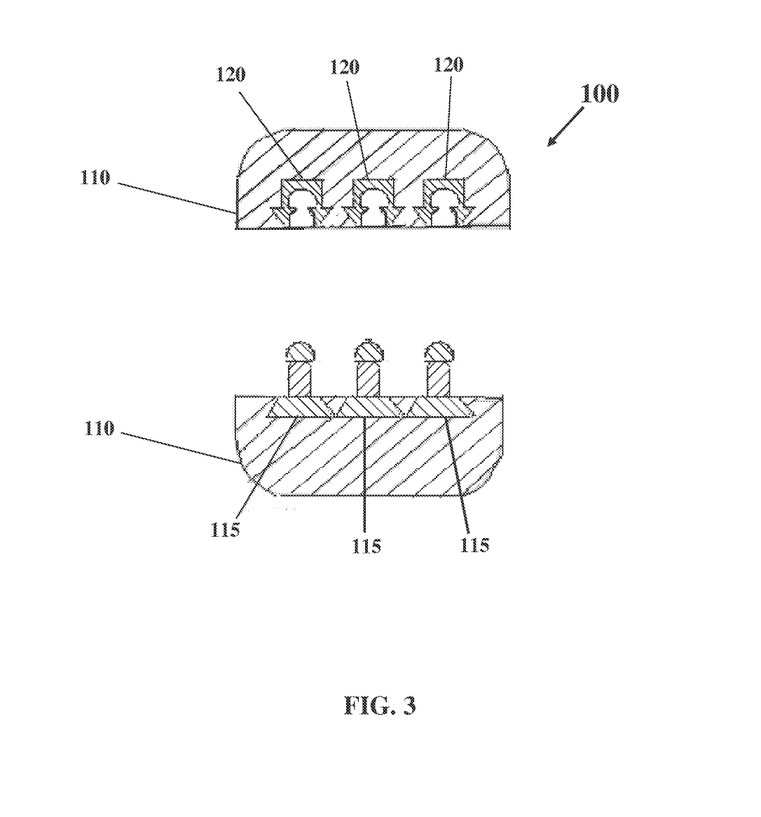

FIG. 3 is an illustration of a cross-sectional side view of one embodiment of the floatation device with fasteners embedded in the float portions and shows the floatation device before combining the float portions. As shown in FIG. 3, one embodiment of the floatation device 100 may comprise: float portions 110, male fasteners 115, and female fasteners 120. The float portions 110 may form into a single float or floatation device 100 when combined. As discussed above, the male fasteners 115 and female fasteners 120 may be aligned and embedded inside the holes 125 of the float portions 110, such that when the male fasteners 115 and female fasteners 120 mate or engage, the float portions 110, in combination with the male fasteners 115 and female fasteners 120, may combine to form a float.

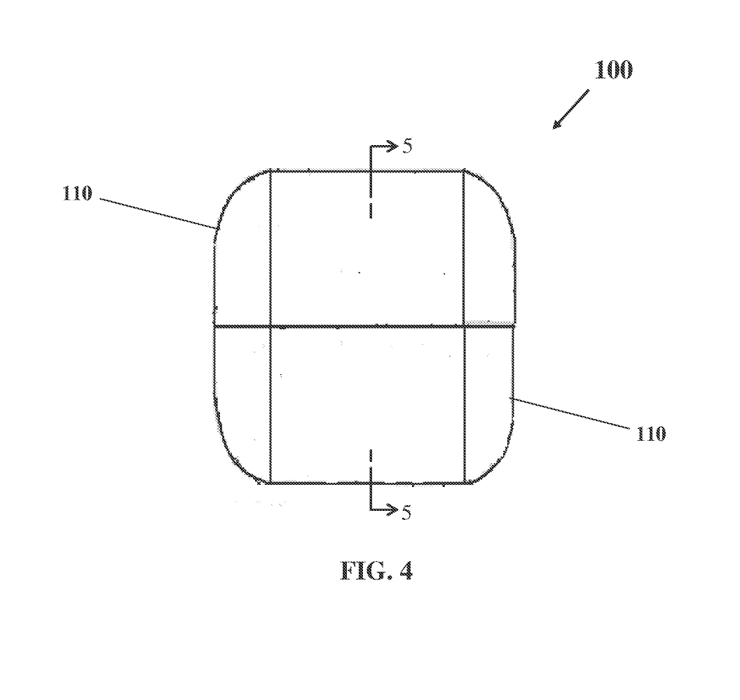

FIG. 4 is an illustration of a side view of one embodiment of the floatation device and shows the floatation device after combining the float portions. As shown in FIG. 4, one embodiment of the floatation device 100 may comprise two float portions 110, which may form a floatation device. Although FIG. 4 only shows two float portions 110 combined, the floatation device 100 may comprise any number of float portions without deviating from the scope of the invention.

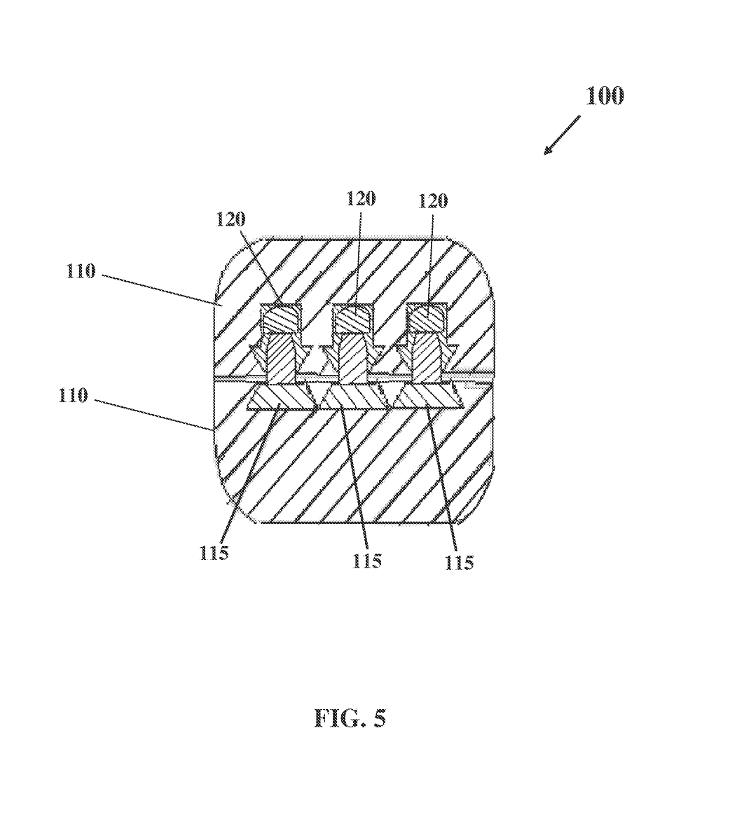

FIG. 5 is an illustration of a cross-sectional side view of one embodiment of the floatation device with fasteners and shows the floatation device after combining the float portions. As shown in FIG. 5, one embodiment of the floatation device 100 may comprise: float portions 110, male fasteners 115, and female fasteners 120. The float portions 110 may form into a single float when combined. The male fasteners 115 and female fasteners 120 may be aligned and embedded inside the holes 125 of the float portions 110, such that when the male fasteners 115 and female fasteners 120 mate or engage, the float portions 110, in combination with the male fasteners 115 and female fasteners 120, may combine to form a float.

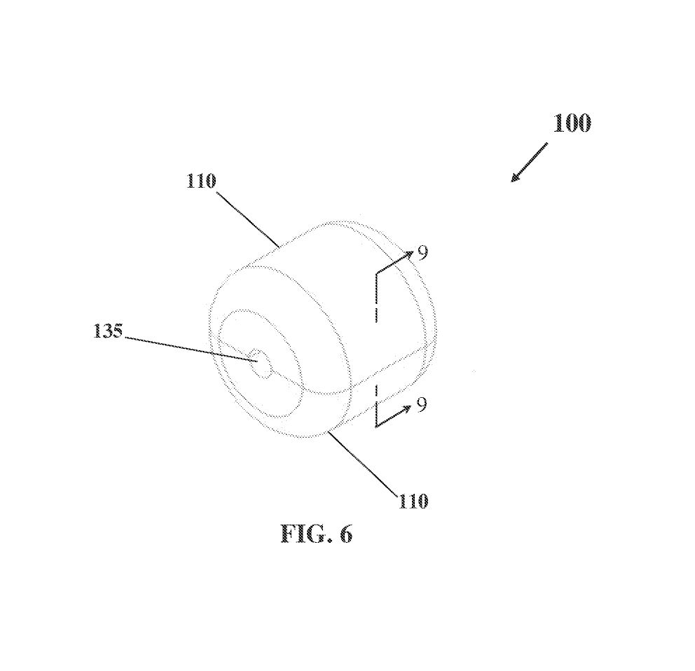

FIG. 6 is an illustration of a perspective view of one embodiment of the floatation device after combining the float portions. As shown in FIG. 6, one embodiment of the floatation device 100, when combined as a float, may comprise float portions 110 and a through hole 135. The through hole 135 may be a hole that passes all the way through the float, but may also be a blind hole, which does not go all the way through the float. The through hole 135 may be configured to receive, attach, or interconnect with a portion of the fishing net, to provide the fishing net with buoyancy. The through hole 135 may allow the float to be fixedly attached to the fishing net, but may allow the float to slide or glide along the fishing net. Additionally, the fishing net may be typically constructed of any manmade or non-manmade material, which may include floats, float line, collar webbing, chaffing, and lead line.

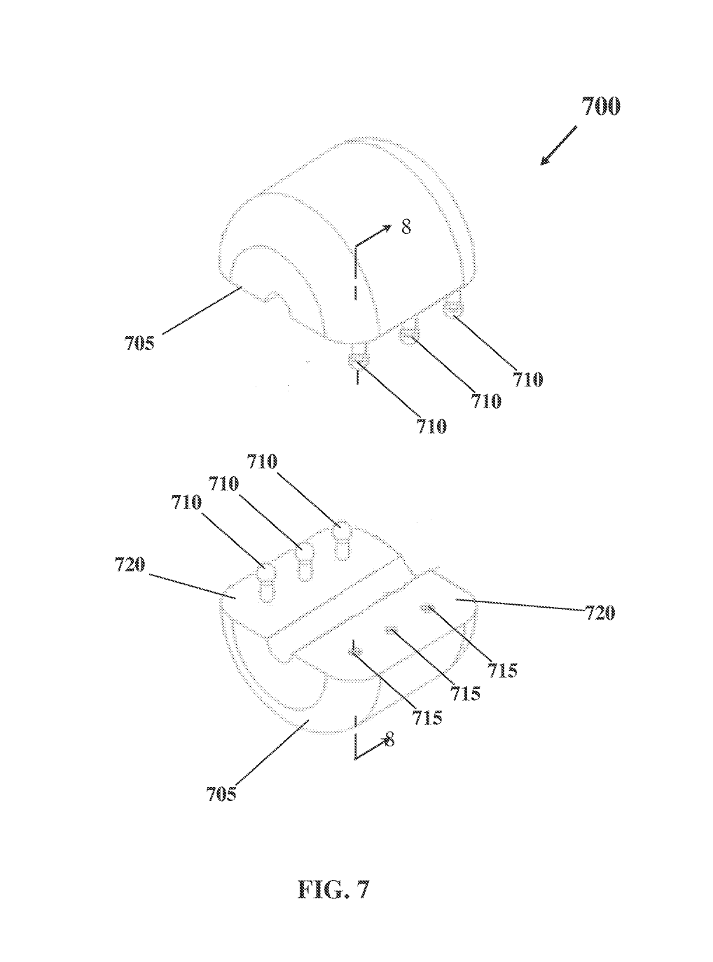

FIG. 7 is an illustration of a perspective view of one embodiment of the floatation device with protrusions and shows the floatation device before combining the float portions. As shown in FIG. 7, another embodiment of the floatation device 700 may comprise: float portions 705, protrusions 710, and holes 715. Similar to the male fasteners 115 and female fasteners 120, the protrusions 710 and holes 715 may be aligned on the contact surface 720 of the float portions 705, such that when the protrusions 710 and holes 715 mate or engage, the float portions 705 may combine to form a single float or floatation device 700. Additionally, the contact surfaces 720 may comprise an adhesive in order to increase the bond or fastening strength when the float portions 705 are combined. Although FIG. 7 only shows the floatation device 700 with protrusions, the floatation device may comprise a combination of both protrusions and fasteners.

In another embodiment, the protrusions 710, like the fasteners, may be constructed of light-weight materials, such as hardened plastic or polymers, but any natural or manmade material may be used. Although FIG. 7 only shows three pairs of protrusions 710 and holes 715, any amount of protrusions and holes may be used.

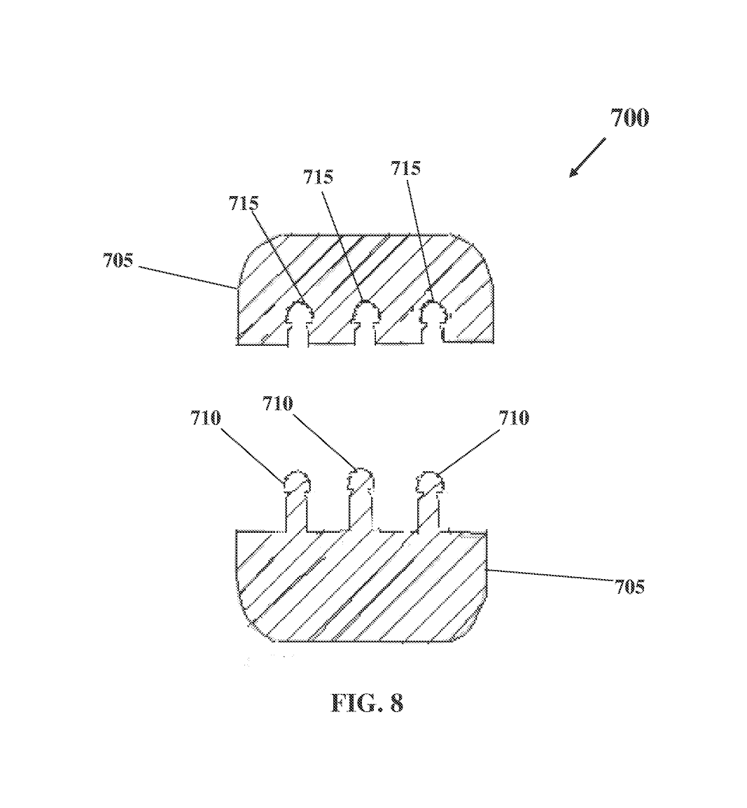

FIG. 8 is an illustration of a cross-sectional side view of one embodiment of the floatation device with protrusions and shows the floatation device before combining the float portions. As shown in FIG. 8, another embodiment of the floatation device 700 may comprise: float portions 705, holes 715, and protrusions 710. The holes 715 and protrusions 710, as discussed above, may be aligned such that when the holes 715 and protrusions 710 mate or engage, the float portions 705 may combine to form a float or floatation device 700.

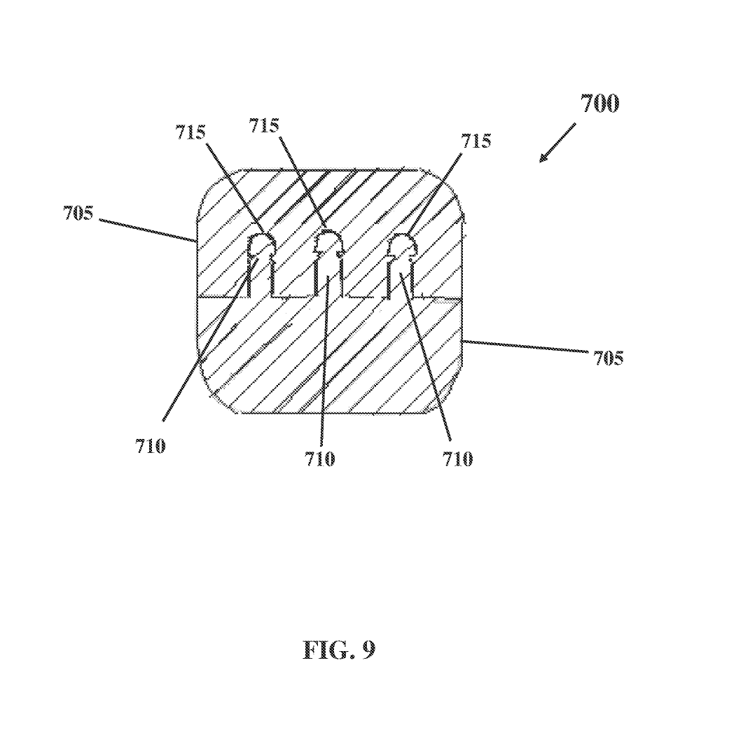

FIG. 9 is an illustration of a cross-sectional side view of one embodiment of the floatation device with protrusions and shows the floatation device after combining the float portions. As shown in FIG. 9, another embodiment of the floatation device 700 may comprise: float portions 705, protrusions 710, and holes 715. The protrusions 710 and holes 715 may mate or engage to form a single float or floatation device 700.

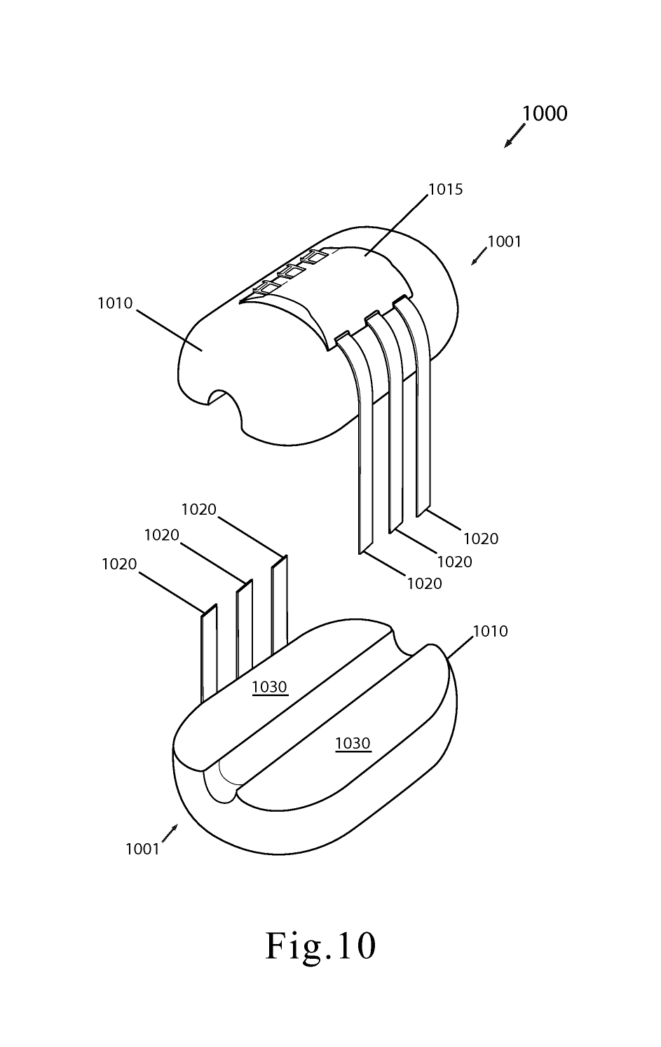

FIG. 10 is an illustration of a perspective-exploded view of another embodiment of the floatation device with fasteners. As shown in FIG. 10, another embodiment of the floatation device 1000 may comprise: one or more float portion assemblies 1001, wherein each float portion assembly may comprise: a float portion 1010, a guide 1015, and fasteners 1020. As discussed above, the float portions 1010 may be any structural pieces of the float or floatation device, which may be used for fishing nets such as seines. The float portions 1010 may also be configured to form a single, cylindrical float when combined and may be constructed of any other materials such as foam, plastic, metal, cork, and wood. While FIG. 10 shows an exploded view of a cylindrical-shaped float, the floatation device may be configured in any shape or form such as square, rectangle, oval, and sphere. Additionally, while FIG. 10 only shows two float portions 1010 as half pieces of the float, multiple pieces of float portions such as three, four, or five pieces or a single float portion may be used.

FIG. 10 shows the float portions 1010 as two half pieces of a single float, which may comprise a contact surface 1030, which is typically a flat-surface area in which the float portions 1010 may contact and/or otherwise matingly engage with each other. Although FIG. 10 shows the contact surface 1030 as a flat surface area, the contact surface 1030 may be unbalanced or irregular. The contact surface 1030 may also comprise an adhesive to increase the strengthening bond or fastening strength of the fasteners when the float portions 1010 are combined. The adhesive is typically a glue, epoxy, or cement compound but may be constructed of any manmade or non-manmade composite that increases the fastening strength of the float portions 1010.

FIG. 10 also shows the guide 1015 and fasteners 1020. The fasteners may be any type of fasteners configured to wrap or fasten a cork portion assembly 1001 to another cork portion assembly 1001. In one embodiment, the fasteners are generally flexible and may be straps or zip tie fasteners for fastening and securing the cork portion assemblies together. The guide 1015 may be used to moveably secure the fasteners 1020 onto the float portion 1010 and may also be used to align the fasteners 1020 on the float portion 1010, such that the fasteners 1020 may engage or mate with fasteners 1020 located on a second, opposing float portion 1010. Because float portions 1010 may matingly engage with one another, they may be identical, which may also lower production costs. Also, the fasteners 1020 may be aligned by the guide 1015, such that when the fasteners 1020 mate or engage with each other, the float portions assemblies 1001 may combine to form a complete float. Although FIG. 10 shows a set of three of fasteners, any amount of fasteners to be used, including as few as one, so long as the float portion assemblies 1001 are capable of being combined as a single float. The fasteners may be configured to wrap around the float portions in one direction or may be configured to wrap around the float portions in various directions.

Typically, guide 1015 is a separate piece that is securely fastened to the float portions 1010, such that the fasteners 1020 pass partially through openings in the guide 1015. The fasteners 1020 may be prevented from passing entirely through the openings of the guide 1015, such that, when fasteners 1020 are connected to an opposing float portion 1010, the fasteners may not be accidentally removed from guide 1015. Alternatively, the guide 1015 may be removably attached to float portion 1010. Alternatively, guide 1015 may be an integrated portion of the float portion 1010, such that it is not a separate piece and the float portion 1010 directly engages with the fasteners 1020. Alternatively, the guide 1015 and fasteners 1020 may be an integrated unitary assembly that is securely connected to float portion 1010. Alternatively, guide 1015, fasteners 1020, and the float portion 1010 may be a single unitary assembly.

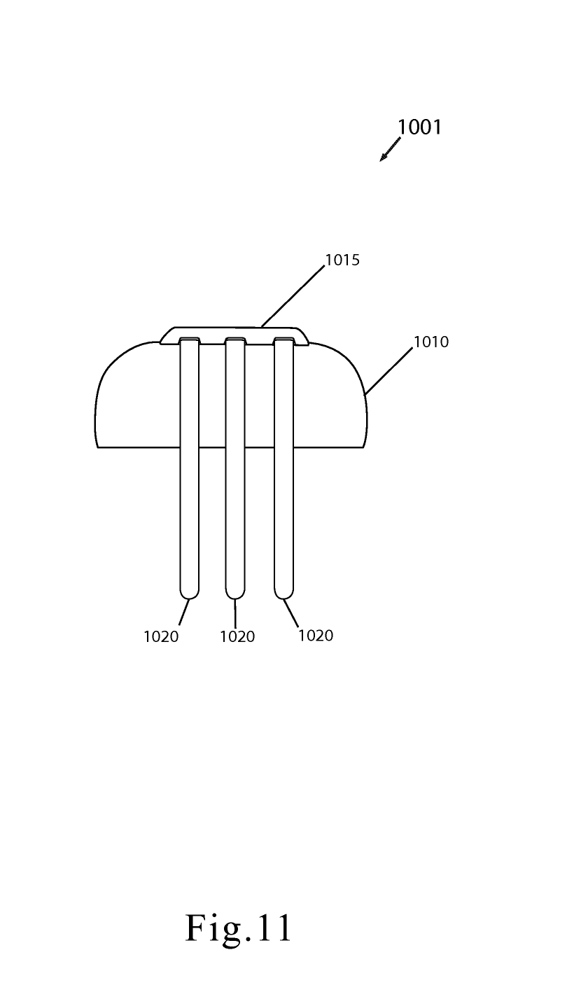

FIG. 11 is an illustration of a right-side view of one embodiment of a float portion assembly and shows the float portion assembly before combining the float portions. As shown in FIG. 11, one embodiment of the float portion assembly 1001 may comprise: a float portion 1010, guide 1015, and fasteners 1020. As discussed above, the fasteners 1020 are generally any device that mechanically joins or affixes two or more objects together, including without limitation, zip tie fasteners, Velcro® strap fasteners, and clip strap fasteners. The fasteners 1020 are generally constructed of any flexible, semi-flexible, or rigid material such as high-strength plastic, polymers, or metals, but may be constructed of any natural or manmade material. In a preferred embodiment, the fasteners 1020 are strap fasteners such as zip tie fasteners, Velcro® strap fasteners, and/or strap fasteners utilizing a quick release clip. Furthermore, the fasteners 1020 may be adjustable, such that the user may adjust the length of the strap fastener to tighten the float portion onto the rope of the fishing net.

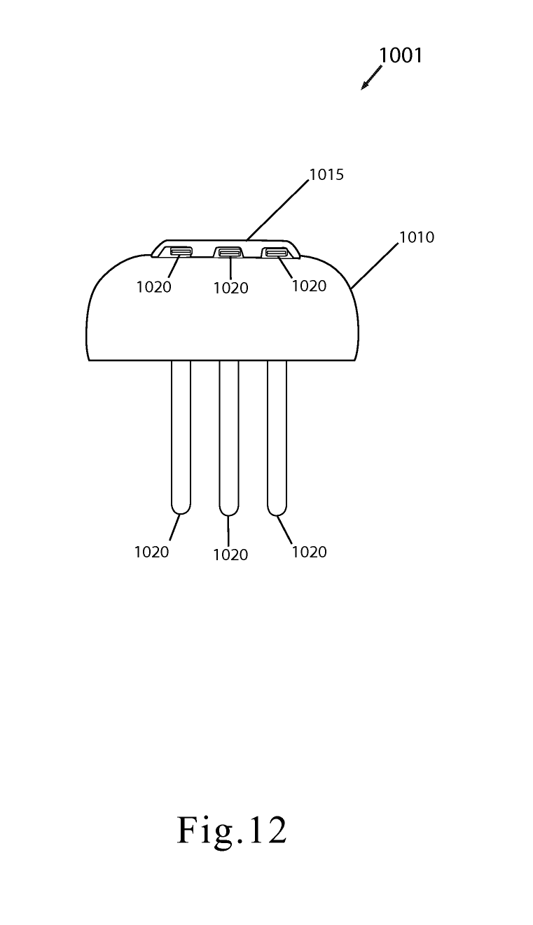

FIG. 12 is an illustration of a left-side view of one embodiment of the float portion assembly and shows the float portion assembly before combining the float portions. As shown in FIG. 12, one embodiment of the float portion assembly 1001 may comprise: a float portion 1010, guide 1015, and fasteners 1020.

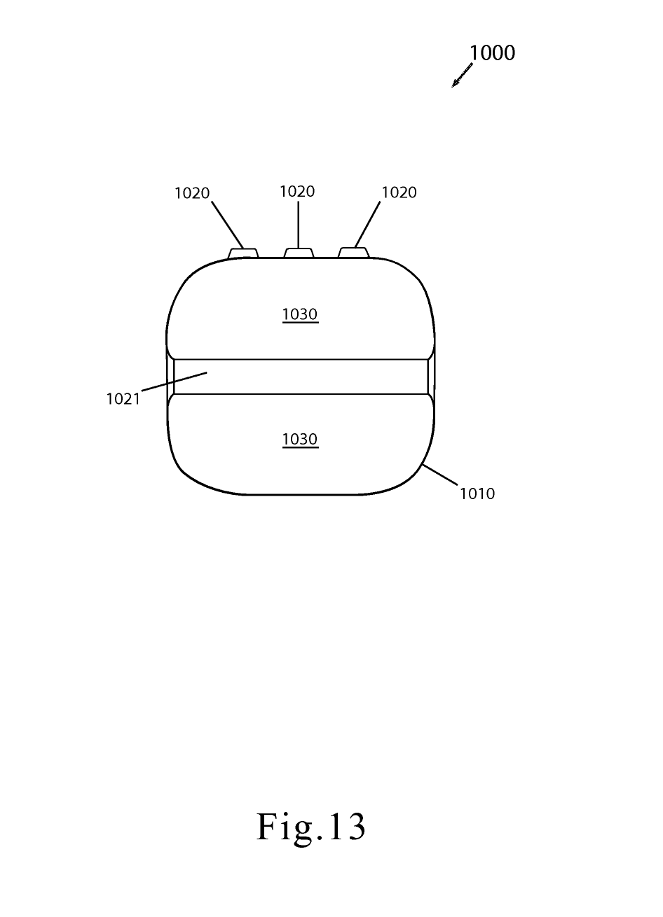

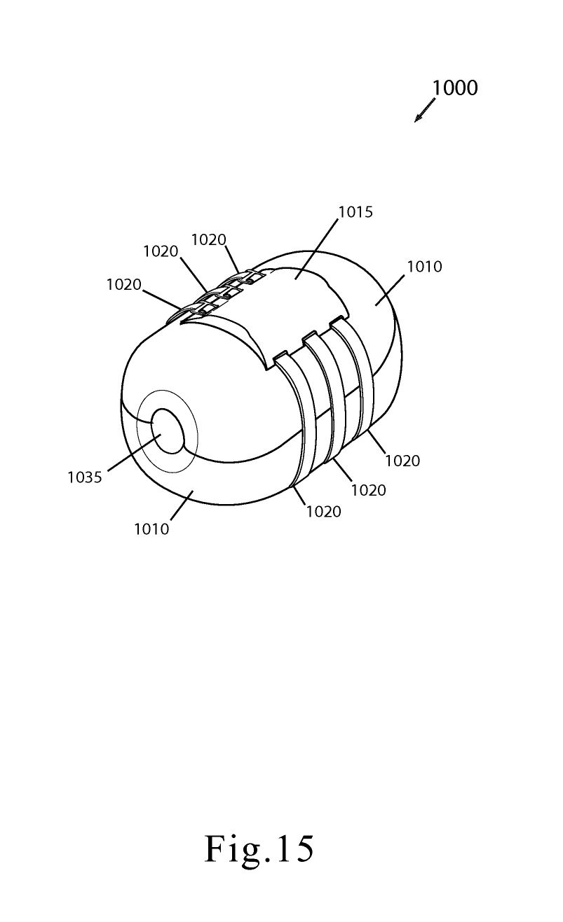

FIG. 13 is an illustration of a bottom view of one embodiment of the float portion assembly and shows the float portion assembly before combining the float portions. As shown in FIG. 13, one embodiment of the float portion assembly 1001 may comprise: a float portion 1010, fasteners 1020, indent 1021, and contact surface 1030. The indent 1021 may be a semi-circular indentation and may be configured to form a through hole 1035 (shown in FIG. 15) when the float portions 1010 combine to form a float. FIG. 13 also shows contact surfaces 1030, which may comprise an adhesive to help fasten the float portions 1010 when the float portions 1010 combine.

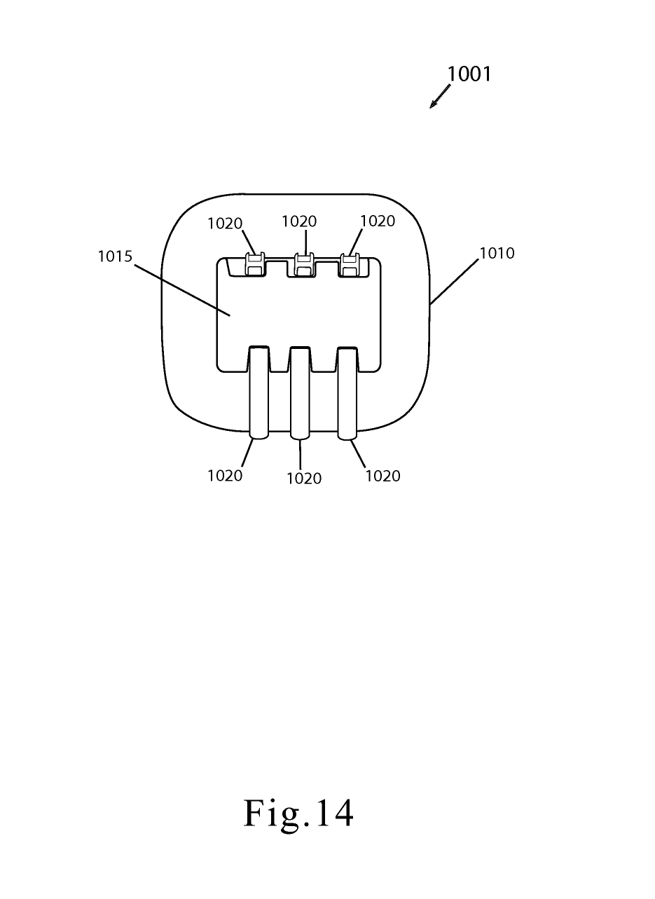

FIG. 14 is an illustration of a top view of one embodiment of the float portion assembly and shows the float portion assembly before combining the float portions. As shown in FIG. 14, one embodiment of the float portion assembly 1001 may comprise: a float portion 1010, guide 1015, and fasteners 1020. As discussed above, the fasteners 1020 may mechanically join or affixed two or more objects together, and may be constructed of any flexible, semi-flexible, or rigid material. In a preferred embodiment, the fasteners 1020 are strap fasteners, which may be adjustable, such that the user may adjust the length of the strap fastener.

FIG. 15 is an illustration of a perspective view of one embodiment of the floatation device and shows the floatation device after combining the float portions. As shown in FIG. 15, one embodiment of the floatation device 1000, when combined as a float, may comprise float portions 1010, guide 1015, fasteners 1020, and a through hole 1035. The through hole 1035 may be a hole that passes all the way through the float, but may also be a blind hole, which does not go all the way through the float. The through hole 1035 may be configured to receive, attach, or interconnect with a portion of the fishing net, to provide the fishing net with buoyancy. The through hole 1035 may allow the float to be fixedly attached to the fishing net, but may allow the float to slide or glide along the fishing net. Additionally, the fishing net may be typically constructed of any manmade or non-manmade material, which may include floats, float line, collar webbing, chaffing, and lead line.

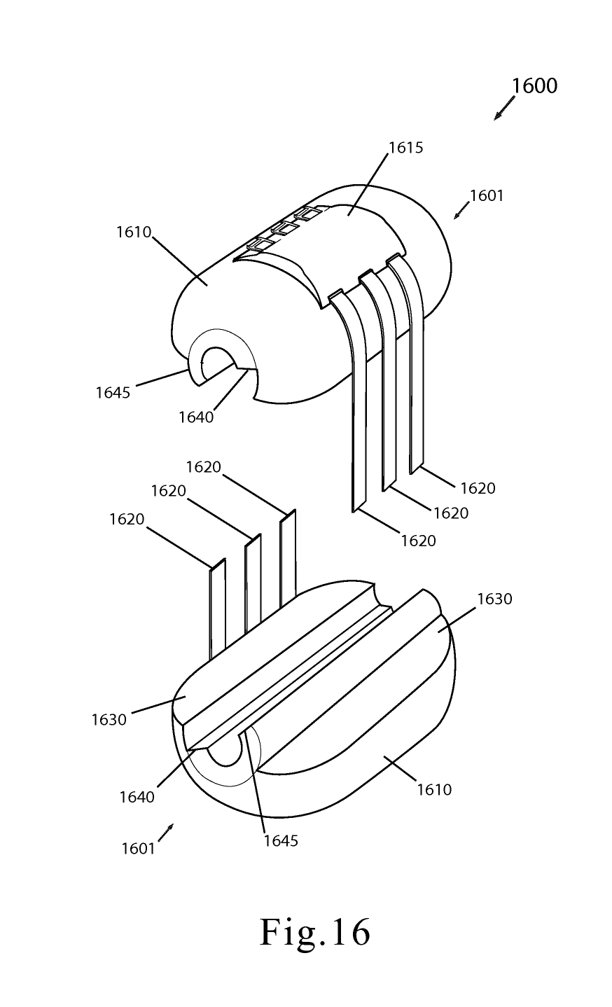

FIG. 16 is an illustration of a perspective-exploded view of another embodiment of the floatation device. As shown in FIG. 16, another embodiment of the floatation device 1600 may comprise: one or more float portion assemblies 1601, wherein each float portion assembly 1601 may comprise: float portions 1610, guide 1615, fasteners 1620, recess 1640, and projection 1645. As discussed above, the float portions 1610 may be any structural pieces of the float, which may be used for fishing nets such as seines. The float portions 1610 may also be configured to form a single, cylindrical float when combined. While FIG. 16 shows an exploded view of a cylindrical-shaped float, the floatation device may be configured in any shape or form such as square, rectangle, oval, and sphere. Additionally, while FIG. 16 only shows two float portions 1610 as half pieces of the float, multiple pieces of float portions or a single piece of float portion may be used.

FIG. 16 shows the float portions 1610 as two half pieces of a single float, which may comprise a contact surface 1630, which is typically a flat-surface area in which the float portions 1610 may contact each other. Although FIG. 16 shows the contact surface 1630 as a flat surface area, the contact surface 1630 may be unbalanced or irregular. The contact surface 1630 may comprise an adhesive to increase the strengthening bond or fastening strength of the fasteners when the float portions 1610 combine. The adhesive is typically a glue, epoxy, or cement compound but may be constructed of any manmade or non-manmade composite that increases the fastening strength of the float portions 1610.

FIG. 16 also shows the guide 1615 and fasteners 1620. The guide 1615 may be used to moveably secure the fasteners 1620 onto the float portion 1610 and may also be used to align the fasteners 1620 to the float portion 1610, such that the fasteners 1620 may engage or mate with fasteners 1620 located on a second float portion 1610. Also, the fasteners 1620 may be aligned by the guide 1615, such that when the fasteners 1620 mate or engage with each other, the float portion assemblies 1601 may combine to form a float. Although FIG. 16 only shows a set of three of fasteners, any amount of fasteners to be used, so long as the float portions 1610 are capable of being combined as an essentially complete float. The fasteners may also be configured to wrap around the float portions in one direction or may be configured to wrap around the float portions in various directions.

Finally, FIG. 16 shows the float portions 1610 with a recess 1640 and projection 1645. The recess 1640 is generally an indentation located at a part of the float portion and is generally part of the through hole. The projection 1645 is generally a part of the float portion that projects outwards and may be located near the through hole. In this embodiment, the recess 1640 may mate or engage with the projection 1645 of another float portion 1610, such that two or more float portion assemblies 1601 may matingly combine to form as one float. The recess 1640 and projection 1645 may be any shapes or sizes, so long as projection 1645 is able to matingly engage with the recess 1640 of another float portion. Each float portion may have a single recess 1640 and single projection 1645. However, in this embodiment, each float portion may have any number of recesses and projections. Furthermore, any number of recesses and projections may be combined on a single side of the float portion 1645, and each recess and projection may be made in a variety of shapes and sizes. Although FIG. 16 shows a single recess 1640 and projection 1645 for each float portion 1610, each float portion may comprise any number of recesses and projections. For example, the surface area of the recess or projection may be an unbalanced or irregular surface, but may be configured to engage with another recess or projection of a different float portion.

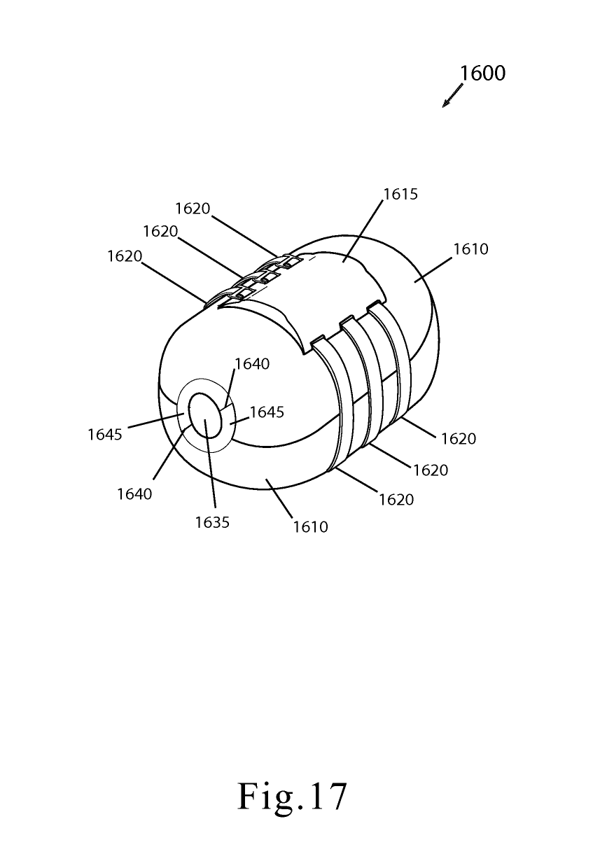

FIG. 17 is an illustration of a perspective view of one embodiment of the floatation device and shows the floatation device after combining the float portion assemblies. As shown in FIG. 17, another embodiment of the floatation device 1600 may comprise: float portions 1610, guide 1615, fasteners 1620, through hole 1635, recess 1640, and projection 1645. FIG. 17 shows that the recess 1640 may engage with projection 1645. FIG. 17 also shows that fasteners 1620 may be used to fasten and secure the float portions 1610 after the float portions 1610 have been combined. The through hole 1635 may be a hole that passes all the way through the float, but may also be a blind hole, which does not go all the way through the float. The through hole 1635 may also be configured to receive, attach, or interconnect with a portion of the fishing net, to provide the fishing net with buoyancy. The through hole 1635 may allow the float to be fixedly attached to the fishing net, but may allow the float to slide or glide along the fishing net. Additionally, the fishing net may be typically constructed of any manmade or non-manmade material, which may include floats, float line, collar webbing, chaffing, and lead line. Furthermore, although FIG. 17 shows the float portions fastened and secured by strap fasteners, any type of fasteners may be used to fasten and secure the float portions.

In preparing or applying the float or floatation device 100, 700, 1000, 1600 to a fishing net or rope, the user typically combines the float portion assemblies 1001, 1601 or float portions 110, 705, 1010, 1610 in combination with fasteners 115, 120, 1020, 1620 and/or protrusions 710. When the float portions 110, 705, 1010, 1620 combine, the through hole 1035, 1635 may circumscribes or encircles the fishing net or rope. The adhesive material may also be included on the contact surfaces 130, 720, 1030, 1630 to strengthen the fastening of the float portions 110, 705, 1010, 1610. After the float portions 110, 705, 1010, 1610 are combined to form a float for the fishing net, the float or floatation device 100, 700, 1000, 1600 may provide buoyancy for the fishing net.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A floatation device for fishing nets, comprising:
one or more float portions; and
one or more fasteners;
wherein said one or more float portions are configured to engage onto a portion of a fishing net;
wherein said one or more fasteners are configured to fasten and secure said one or more float portions around said portion of said fishing net, such that, when said one or more fasteners fasten said one or more float portions around said portion of said fishing net, said one or more float portions function as a float.

2. The floatation device, according to claim 1, wherein a first end of said one or more fasteners comprise at least one male fastener; and
wherein a second end of said one or more fasteners comprise at least one female fastener.

3. The floatation device, according to claim 1, wherein said one or more fasteners are one or more strap fasteners.

4. The floatation device, according to claim 1, wherein said one or more float portions are at least two float portions;
wherein said at least two float portions comprise one or more contact surfaces;
wherein said one or more contact surfaces comprise an adhesive; and
wherein said adhesive increases a fastening strength of said one or more fasteners when said at least two float portions combine into said float.

5. The floatation device, according to claim 1, wherein said one or more float portions are one float portion.

6. The floatation device, according to claim 1, wherein said one or more float portions are two float portions.

7. The floatation device, according to claim 1, wherein said portion of said fishing net is a rope portion.

8. The floatation device, according to claim 1, wherein said one or more fasteners are three fasteners.

9. The floatation device, according to claim 1, wherein said one or more float portions are configured to float.

10. The floatation device, according to claim 1, wherein said one or more float portions, when combined, form one or more through holes;
wherein said one or more through holes are configured to engage with said portion of said fishing net.

11. The floatation device, according to claim 10, wherein said one or more float portions are two float portions, a first portion and a second portion;
wherein each of said two float portions is further comprised of at least one recess and at least one projection;
wherein said at least one recess of said first portion is configured to engage with said projection of said second portion; and
wherein said at least one recess of said second portion is configured to engage with said projection of said first portion.

12. A floatation device for fishing nets, comprising:
two or more float portions; and
one or more fasteners;
wherein said two or more float portions are configured to engage onto a rope portion of a fishing net;
wherein said two of more float portions are configured to form a float when combined;
wherein said one or more fasteners are aligned and positioned on an outside surface of said two or more float portions;
wherein said one or more fasteners are configured to fasten and secure said two or more float portions around said rope portion of said fishing net, such that, when said one or more fasteners fasten said two or more float portions around said rope portion of said fishing net, said two or more float portions combine to form a float.

13. The floatation device, according to claim 12, wherein said two or more float portions comprise one or more contact surfaces;
wherein said one or more contact surfaces comprise an adhesive; and
wherein said adhesive increases a fastening strength of said one or more fasteners when said two or more float portions combine.

14. The floatation device, according to claim 13, wherein said two or more float portions are two float portions, a first float portion and a second float portion.

15. The floatation device, according to claim 14, wherein said two or more float portions are configured to float.

16. The floatation device, according to claim 15, wherein said one or more fasteners are two fasteners.

17. The floatation device, according to claim 15, wherein said one or more fasteners are three fasteners.

18. The floatation device, according to claim 15, wherein said two or more float portions, when combined, form one or more through holes;
wherein said one or more through holes are configured to engage with said rope portion of said fishing net.

19. The floatation device, according to claim 18, wherein each of said two float portions is further comprised of at least one recess and at least one projection;
wherein said at least one recess of said first portion is configured to engage with said projection of said second portion; and
wherein said at least one recess of said second portion is configured to engage with said projection of said first portion.

20. A floatation device for fishing nets, comprising:
two float portions; and
three fasteners;
wherein said two float portions are a first float portion and a second float portion;
wherein said two or more float portions are configured to float;
wherein said two float portions are configured to engage onto a rope portion of a fishing net;
wherein said two float portions are configured to form a float when combined;
wherein said two float portions, when combined, form one or more through holes;
wherein said one or more through holes are configured to engage with said rope portion of said fishing net;
wherein said three fasteners are aligned and positioned on an outside surface of said two float portions; and
wherein said three fasteners are configured to fasten and secure said two float portions around said rope portion of said fishing net, such that, when said three fasteners fasten said two float portions around said rope portion of said fishing net, said two float portions combine to form said float.
